(19) United States
(12) Patent Application Publication
(10) Pub. No.: US 2017/0323610 A1
(43) Pub. Date: Nov. 9, 2017

(54) LIQUID CRYSTAL DISPLAY DEVICE AND DRIVING METHOD THEREOF

(71) Applicant: Chunghwa Picture Tubes, LTD., Taoyuan City (TW)

(72) Inventor: Hsiang-Tan Lin, Keelung City (TW)

(21) Appl. No.: 15/177,161

(22) Filed: Jun. 8, 2016

(30) Foreign Application Priority Data
May 9, 2016 (CN) 201610300481.7

(51) Int. Cl. G09G 3/36

(52) U.S. Cl. CPC G09G 3/3677; G09G 3/3688; G09G 2320/0247; G09G 2320/0214; G09G 2330/021; G09G 2320/0233

(57) ABSTRACT

The invention provides a liquid crystal display device and a driving method thereof. The liquid crystal display device includes a liquid crystal display panel and a driver. The liquid crystal display panel includes scan lines, data lines, and pixel units. The pixel units are respectively disposed at intersections of the scan lines and the data lines, and the pixel units are divided into pixel groups. The driver is coupled to the scan lines and the data lines and respectively provides scan driving signals and data driving signals to the scan lines and the data lines according to display data, so as to drive the pixel groups on the liquid crystal display panel at different driving time points or with a fluctuating driving frequency, thereby effectively preventing a flicker phenomenon that occurs when a scan driving frequency is reduced and significantly improving the display quality of the liquid crystal display device.

### CROSS-REFERENCE TO RELATED APPLICATION

This application claims the priority benefit of China application serial no. 201610300481.7, filed on May 9, 2016. The entirety of the above-mentioned patent application is hereby incorporated by reference herein and made a part of this specification.

### BACKGROUND OF THE INVENTION

### Field of the Invention

The invention relates to a display device and particularly relates to a liquid crystal display device and a driving method thereof.

### Description of Related Art

Field-effect transistors are extensively used as unit components of the integrated circuit for semiconductor memory, high-frequency signal amplifying components, and components of the display assembly for driving liquid crystal display device, for example. A transistor that has been formed into a thin film is called TFT (thin film transistor) which can be used in flat panel displays.

The traditional a-Si thin film transistor has an obvious leakage current problem. An overly large leakage current will cause charges in the capacitor of the liquid crystal display panel to be lost through the channel of the thin film transistor even when the thin film transistor is off, which causes the voltage to drop and results in insufficient orientation of the liquid crystal and incorrect brightness. In recent years, TFT displays using IGZO have been developed to significantly improve the leakage current problem and thereby reduce the scan driving frequency. For example, the frame rate may be reduced from 60 Hz to 1 Hz to achieve power saving.

After the scan driving frequency is reduced, however, the current IGZO display panels may have a flicker phenomenon. For example, at the frame rate of 1 Hz, the user may sense a sudden increase of brightness as the frame is refreshed every second. Thus, the flicker phenomenon occurs at the frequency of 1 Hz.

### SUMMARY OF THE INVENTION

The invention provides a liquid crystal display device and a driving method thereof for effectively preventing a flicker phenomenon that occurs when a scan driving frequency is reduced.

The liquid crystal display device of the invention includes a liquid crystal display panel and a driver. The liquid crystal display panel includes a plurality of scan lines, a plurality of data lines, and a plurality of pixel units. The pixel units are respectively disposed at a plurality of intersections of the scan lines and the data lines, and are coupled to the corresponding scan lines and data lines. The pixel units are divided into a plurality of pixel groups. The driver is coupled to the scan lines and the data lines and respectively provides a plurality of scan driving signals and a plurality of data driving signals to the scan lines and the data lines according to display data, so as to drive the pixel groups at different driving time points or with a fluctuating driving frequency.

In an embodiment of the invention, the driver respectively drives the corresponding pixel groups at different time points in the same frame period.

In an embodiment of the invention, each unit driving period of the liquid crystal display device includes a first period and a second period, and the driver drives the pixel groups with a first driving frequency in the first period and drives the pixel groups with a second driving frequency in the second period.

In an embodiment of the invention, the second driving frequency is higher than the first driving frequency.

In an embodiment of the invention, a brightness of the pixel groups is changed progressively in the second period.

The invention further provides a driving method of a liquid crystal display device, which includes a plurality of scan lines, a plurality of data lines, and a plurality of pixel units. The pixel units are divided into a plurality of pixel groups. The driving method includes the following steps. Display data is received. A plurality of scan driving signals and a plurality of data driving signals are respectively provided to the scan lines and the data lines according to the display data, so as to drive the pixel groups at different driving time points and with a fluctuating driving frequency.

In an embodiment of the invention, the driving method of the liquid crystal display device includes: respectively driving the corresponding pixel groups at different time points in the same frame period.

In an embodiment of the invention, each unit driving period of the liquid crystal display device includes a first period and a second period, and the driving method includes: driving the pixel groups with a first driving frequency in the first period and driving the pixel groups with a second driving frequency in the second period.

In an embodiment of the invention, the second driving frequency is higher than the first driving frequency.

In an embodiment of the invention, a brightness of the pixel groups is changed progressively in the second period.

Based on the above, in the embodiments of the invention, the pixel groups on the liquid crystal display panel are driven at different driving time points or with the fluctuating driving frequency, so as to effectively prevent the flicker phenomenon that occurs when the scan driving frequency is reduced and significantly improve the display quality of the liquid crystal display device.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic view of a liquid crystal display device according to an embodiment of the invention.

FIG. 2 is a schematic view showing pixel group distributions according to an embodiment of the invention.

FIG. 3A to FIG. 3E are diagrams showing the corresponding brightness when the pixel groups in the embodiment of FIG. 2 are driven.

FIG. 4A to FIG. 4E are diagrams showing the corresponding brightness when the pixel groups in the embodiment of FIG. 2 are driven by the conventional driving method.

FIG. 5 is a schematic view showing pixel group distributions according to another embodiment of the invention.

FIG. 6 is a diagram showing the corresponding brightness when the pixel groups are driven.

FIG. 7 is a flowchart showing a driving method of a liquid crystal display device according to an embodiment of the invention.

### DESCRIPTION OF THE EMBODIMENTS

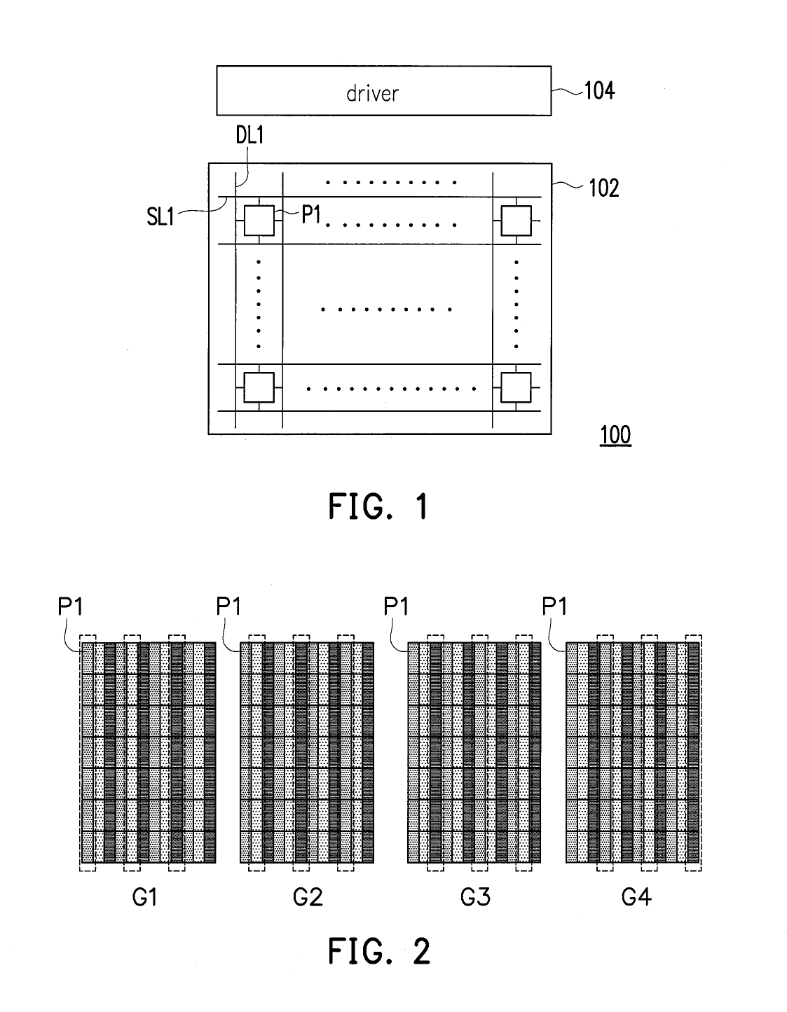

FIG. 1 is a schematic view of a liquid crystal display device according to an embodiment of the invention. Referring to FIG. 1, a liquid crystal display device 100 includes a display panel 102 and a driver 104, wherein the display panel 102 includes a plurality of scan lines SL1, a plurality of data lines DL1, and a plurality of pixel units P1. The display panel 102 is an IGZO display panel, for example, but not limited thereto. The display panel 102 may also be other types of liquid crystal display panels. The pixel units P1 are respectively disposed at a plurality of intersections of the scan lines SL1 and the data lines DL1 and are coupled to the corresponding scan lines SL1 and data lines DL1. In addition, the driver 104 is coupled to the scan lines SL1 and the data lines DL1. For simplicity of the figures, a coupling relationship thereof is not illustrated. Moreover, the pixel units P1 are divided into a plurality of pixel groups, as shown in FIG. 2, wherein the pixel units P1 are arranged alternately in a row direction in an order of red, green, and blue, for example, but not limited thereto. In the embodiment of FIG. 2, the pixel units P1 are divided into four pixel groups G1-G4. However, the invention is not limited thereto. That is, the pixel units P1 may be divided into more or fewer pixel groups. To facilitate the description, FIG. 2 illustrates four pixel arrays for describing the distributions of the four pixel groups G1-G4. However, the four pixel arrays shown in FIG. 2 are actually the same pixel array. In addition, although the pixel array of FIG. 2 only has the pixel units P1 corresponding to seven scan lines and twelve data lines, the number of the pixel units P1 actually included is not limited thereto. That is, the size of the pixel array is not limited to the above. The pixel units corresponding to the 4N+1th data line are divided into the first pixel group G1 (as circled by the dotted line), the pixel units corresponding to the 4N+2th data line are divided into the second pixel group G2 (as circled by the dotted line), the pixel units corresponding to the 4N+3th data line are divided into the third pixel group G3 (as circled by the dotted line), and the pixel units corresponding to the 4N+4th data line are divided into the fourth pixel group G4 (as circled by the dotted line), wherein N is 0 or a positive integer. The driver 104 respectively provides a plurality of scan driving signals and a plurality of data driving signals to the scan lines SL1 and the data lines DL1 according to display data, so as to drive the first pixel group G1 to the fourth pixel group G4 at different driving time points or with a fluctuating driving frequency.

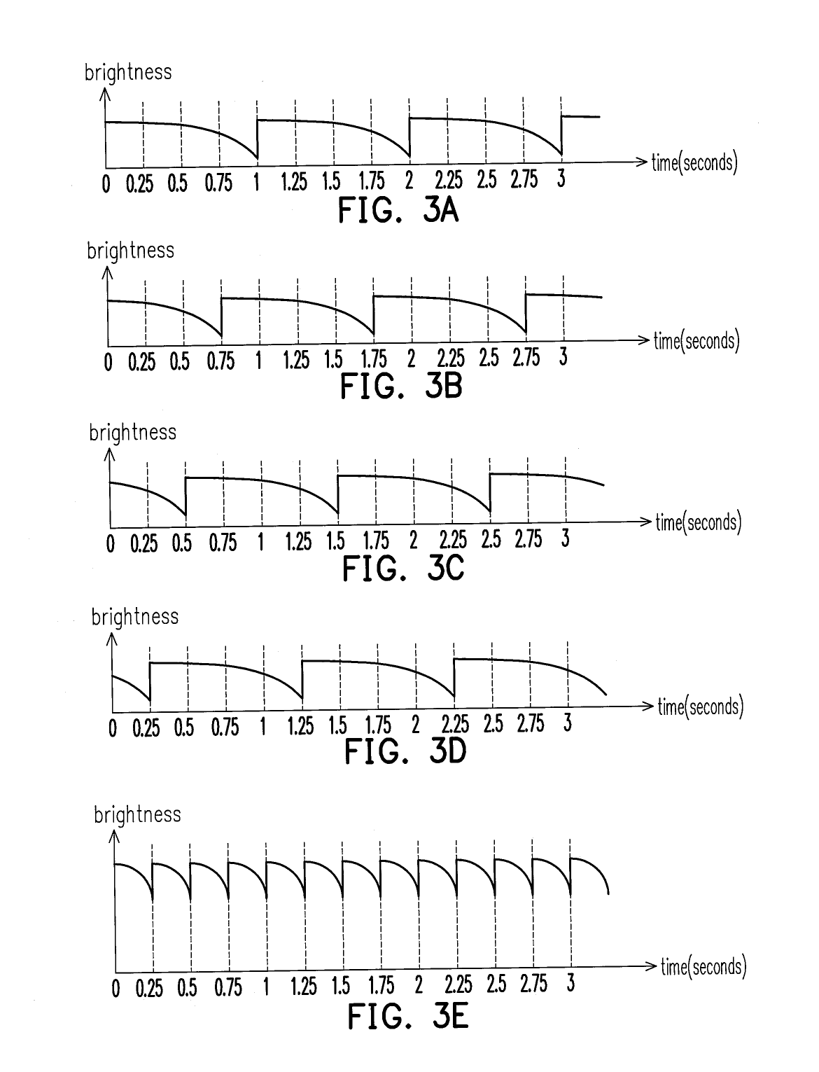

For example, FIG. 3A to FIG. 3E are diagrams showing the corresponding brightness when the pixel groups in the embodiment of FIG. 2 are driven, wherein FIG. 3A to FIG. 3D are diagrams respectively showing the brightness corresponding to the first pixel group G1 to the fourth pixel group G4 when the first pixel group G1 to the fourth pixel group G4 are driven, and FIG. 3E is a diagram showing the superimposed brightness of the first pixel group G1 to the fourth pixel group G4. In the embodiment of FIG. 3A to FIG. 3E, the liquid crystal display device 100 has a frame rate of 1 Hz. That is, the first pixel group G1 to the fourth pixel group G4 are respectively driven (refreshed) one time every second, and the pixel groups are driven at different time points in the same frame period (having a time length of one second). For example, in the embodiment of FIG. 3A to FIG. 3E, the first pixel group G1 to the fourth pixel group G4 are driven sequentially at an interval of 0.25 second. Because a thin film transistor in the pixel unit P1 has a leakage current, the brightness of the first pixel group G1 to the fourth pixel group G4 respectively decreases with time. However, because the first pixel group G1 to the fourth pixel group G4 are respectively driven at different time points, a brightness change obtained by superimposing the brightness of the first pixel group G1 to the fourth pixel group G4 is shown in FIG. 3E. The first pixel group G1 to the fourth pixel group G4 are driven one time every second. That is, the first pixel group G1 to the fourth pixel group G4 change from dark to bright one time at an interval of one second. In contrast thereto, the brightness change obtained by superimposing the brightness of the first pixel group G1 to the fourth pixel group G4 is equivalent to a change at an interval of 0.25 second. Thus, a frequency of brightness change of the image frames displayed by the liquid crystal display device 100 is improved.

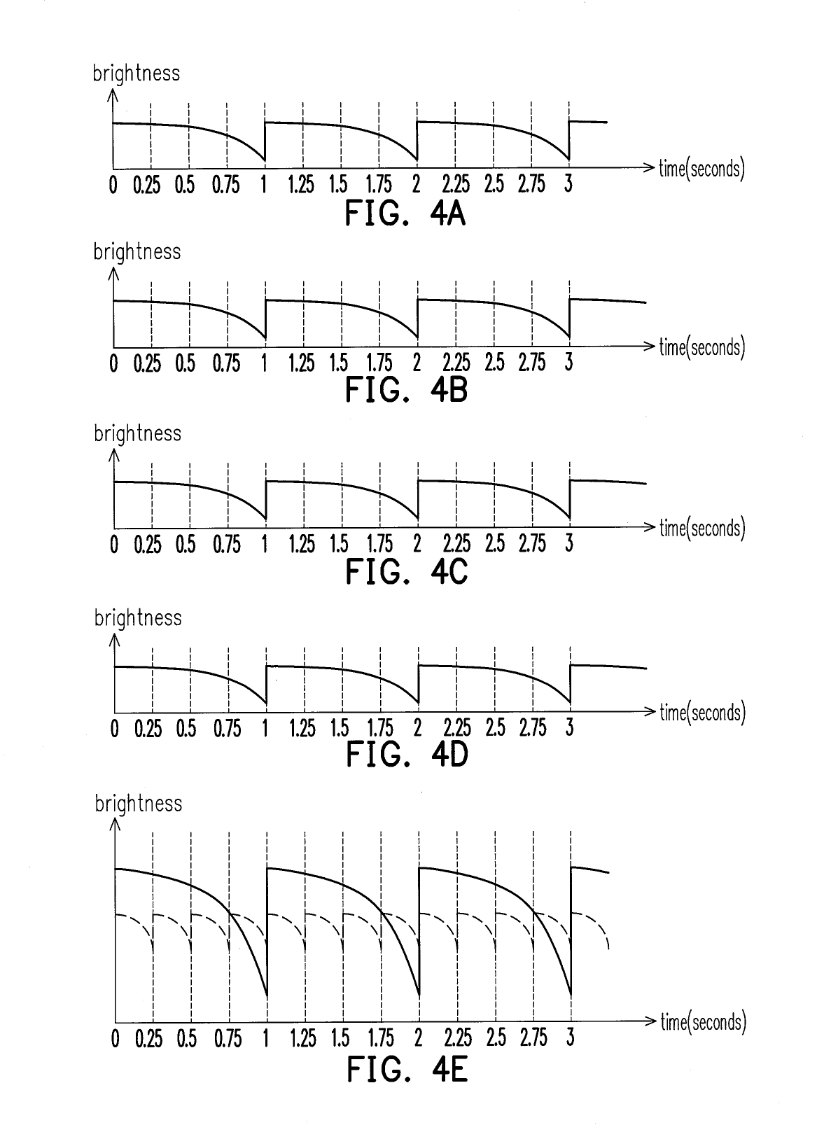

Moreover, in the embodiment of FIG. 3A to FIG. 3E, the brightness change obtained by superimposing the brightness of the first pixel group G1 to the fourth pixel group G4 has a smaller variation in comparison with the conventional technology. FIG. 4A to FIG. 4E are diagrams showing the corresponding brightness when the pixel groups in the embodiment of FIG. 2 are driven by the conventional driving method. As shown in FIG. 4A to FIG. 4D, according to the conventional technology, the first pixel group G1 to the fourth pixel group G4 are driven simultaneously at the same time point. Accordingly, the brightness obtained by superimposing the brightness of the first pixel group G1 to the fourth pixel group G4 still changes from dark to bright one time at an interval of one second, unlike the embodiment of FIG. 3A to FIG. 3E in which the frequency of brightness change of the image frames is improved. Moreover, because the brightness of the first pixel group G1 to the fourth pixel group G4 declines simultaneously due to leakage current, the brightness change obtained by superimposing the brightness of the first pixel group G1 to the fourth pixel group G4 in FIG. 4E has a larger variation than the brightness change obtained by superimposing the brightness of the first pixel group G1 to the fourth pixel group G4 in FIG. 3E (referring to FIG. 4E, the variation of the brightness change of the first pixel group G1 to the fourth pixel group G4 in FIG. 3E is indicated by the dotted line).

According to the embodiment described above, the first pixel group G1 to the fourth pixel group G4 are driven at different time points, so as to achieve an effect of improving the scan driving frequency when the brightness of the first pixel group G1 to the fourth pixel group G4 is superimposed. In addition, the variation of the brightness change is suppressed to prevent the conventional problem that the user may easily sense image flicker, and thereby significantly improve the display quality of the liquid crystal display device 100.

It should be noted that, in some other embodiments, the pixel units may be divided in a manner different from the embodiment of FIG. 2. For example, FIG. 5 is a schematic view showing pixel group distributions according to another embodiment of the invention. Referring to FIG. 5, in comparison with the embodiment of FIG. 2, a first pixel group G1′ in this embodiment includes pixel units (as circled by the dotted line) at intersections corresponding to the odd-numbered scan lines and the odd-numbered data lines, a second pixel group G2′ includes pixel units (as circled by the dotted line) at intersections corresponding to the even-numbered scan lines and the odd-numbered data lines, a third pixel group G3′ includes pixel units (as circled by the dotted line) at intersections corresponding to the odd-numbered scan lines and the even-numbered data lines, and a fourth pixel group G4′ includes pixel units (as circled by the dotted line) at intersections corresponding to the even-numbered scan lines and the even-numbered data lines. A driving method of the first pixel group G1′ to the fourth pixel group G4′ is similar to the driving method described in the embodiment of FIG. 3 and therefore is not repeated hereinafter.

Further, for example, the driver 104 may drive all the pixel groups at a fluctuating driving frequency, that is, drive all the pixel units P1 in the embodiment of FIG. 1 to solve the conventional flicker problem. Each unit driving period, in which the driver 104 drives the pixel units P1, includes a first period and a second period, wherein the driver 104 drives the pixel units P1 with a first driving frequency in the first period and drives the pixel units P1 with a second driving frequency in the second period. The second driving frequency is higher than the first driving frequency. The second period may be set as a period from when the brightness of the pixel units P1 becomes lower than a specific threshold value in the first period to the end of the unit driving period. In a period that the liquid crystal display device 100 displays a static image, the pixel units P1 may have the same brightness at a start time point of each unit driving period. Nevertheless, the invention is not limited thereto. Thus, when the brightness of the pixel units P1 drops, the variation of the brightness change may be reduced by improving the frequency of driving the pixel units P1, so as to improve the flicker problem.

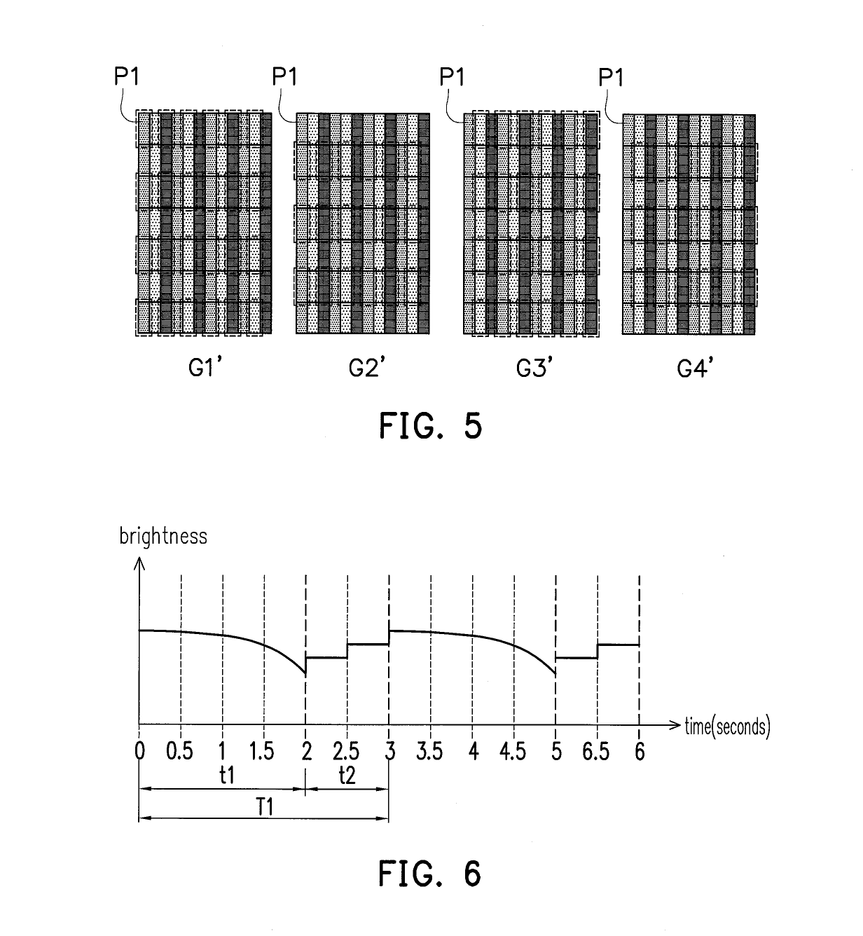

For example, FIG. 6 is a diagram showing the corresponding brightness when all the pixel groups are driven. Referring to FIG. 6, in this embodiment, each unit driving period T1 for driving the pixel units P1 may include a first period t1 and a second period t2, wherein a frequency that the driver 104 drives the pixel units P1 in the second period t2 is higher than a frequency that the driver 104 drives the pixel units P1 in the first period t1. As shown in FIG. 6, in this embodiment, a time length of the first period t1 two seconds while a time length of the second period t2 is one second, and a driving frequency of the pixel units P1 in the first period t1 is 0.5 Hz while a driving frequency of the pixel units P1 in the second period t2 is 2 Hz. In other words, the pixel units P1 are driven one time in the first period t1 (at the 0 second, for example) while the pixel units P1 are driven two times in the second period, t2 (at the 2nd second and the 2.5th second, for example). Human eyes are less sensitive to high-frequency brightness change and progressive brightness change. Therefore, after the brightness of the pixel units P1 gradually declines in the first period t1, by raising the driving frequency of the pixel units P1 (i.e. entering the driving mode of the second period t2) and progressively changing the brightness in the second period t2, the variation of the brightness change may be suppressed effectively. Accordingly, the flicker problem that the user may feel when watching static images is improved significantly, and the overall driving frequency is maintained at 1 Hz for the liquid crystal display device 100 to keep a low frame rate and achieve power saving. The same pixel unit P1 may have the same brightness at a start time point of each unit driving period. For example, in the embodiment of FIG. 6, the same pixel unit P1 has the same brightness at the 0 second and the 3rd second.

It should be noted that, in some other embodiments, the time length of the unit driving period T1 is not limited to the length described in the embodiment of FIG. 6 and may be adjusted according to different situations. Moreover, the unit driving period T1 may also include a plurality of periods having different driving frequencies, which is not limited to the embodiment of FIG. 6. In adjacent two periods, the driving frequency of an even-numbered period (e.g., second period) needs to be higher than the driving frequency of the previous period (e.g., first period).

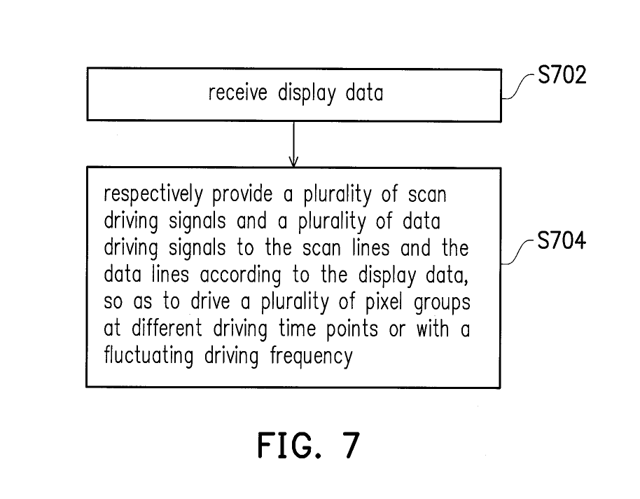

FIG. 7 is a flowchart showing a driving method of the liquid crystal display device according to an embodiment of the invention. Referring to FIG. 7, it is known from the above embodiment that the driving method of the liquid crystal display device includes the following steps. First, display data is received (Step S702). Then, a plurality of scan driving signals and a plurality of data driving signals are respectively provided to the scan lines and the data lines according to the display data, so as to drive a plurality of pixel groups at different driving time points and with a fluctuating driving frequency (Step S704). For example, the corresponding pixel groups may be respectively driven at different time points in the same frame period, so as to improve the flicker problem. Further, for example, each unit driving period of the liquid crystal display device may include a first period and a second period, and all the pixel groups may be driven with a first driving frequency in the first period and may be driven with a second driving frequency in the second period, wherein the second driving frequency is higher than the first driving frequency, and the brightness of multiple pixel groups is changed progressively in the second period. In addition, the same pixel unit may have the same brightness at a start time point of each unit driving period. Nevertheless, the invention is not limited thereto. Accordingly, the liquid crystal display device has a low frame rate in the period of displaying static images, so as to achieve power saving as well as improve the flicker problem.

To sum up, in the embodiments of the invention, the pixel groups on the liquid crystal display panel are driven at different driving time points or with the fluctuating driving frequency, so as to effectively prevent the flicker phenomenon that occurs when the scan driving frequency is reduced and significantly improve the display quality of the liquid crystal display device. In addition, the driving method improves the flicker problem caused by panel leakage current without changing the panel design or using special materials. Therefore, the production costs of the liquid crystal display device are reduced.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A liquid crystal display device, comprising:
a liquid crystal display panel, comprising:
a plurality of scan lines;
a plurality of data lines; and
a plurality of pixel units respectively disposed at a plurality of intersections of the scan lines and the data lines and coupled to the corresponding scan lines and data lines, wherein the pixel units are divided into a plurality of pixel groups; and
a driver coupled to the scan lines and the data lines and respectively providing a plurality of scan driving signals and a plurality of data driving signals to the scan lines and the data lines according to display data to drive the pixel groups at different driving times points or with a fluctuating driving frequency.

2. The liquid crystal display device according to claim 1, wherein the driver respectively drives the corresponding pixel groups at different time points in the same frame period.

3. The liquid crystal display device according to claim 1, wherein each unit driving period of the liquid crystal display device comprises a first period and a second period, and the driver drives the pixel groups with a first driving frequency in the first period and drives the pixel groups with a second driving frequency in the second period.

4. The liquid crystal display device according to claim 3, wherein the second driving frequency is higher than the first driving frequency.

5. The liquid crystal display device according to claim 3, wherein a brightness of the pixel groups is changed progressively in the second period.

6. A driving method of a liquid crystal display device, which comprises a plurality of scan lines, a plurality of data lines, and a plurality of pixel units, wherein the pixel units are respectively disposed at a plurality of intersections of the scan lines and the data lines and are coupled to the corresponding scan lines and data lines and are divided into a plurality of pixel groups, the driving method comprising:
receiving display data; and
respectively providing a plurality of scan driving signals and a plurality of data driving signals to the scan lines and the data lines according to the display data to drive the pixel groups at different driving time points or with a fluctuating driving frequency.

7. The driving method according to claim 6, comprising:
respectively driving the corresponding pixel groups at different time points in the same frame period.

8. The driving method according to claim 6, wherein each unit driving period of the liquid crystal display device comprises a first period and a second period, and the driving method comprises:
driving the pixel groups with a first driving frequency in the first period and driving the pixel groups with a second driving frequency in the second period.

9. The driving method according to claim 8, wherein the second driving frequency is higher than the first driving frequency.

10. The driving method according to claim 8, wherein a brightness of the pixel groups is changed progressively in the second period.
